(19) United States
(12) Patent Application Publication
(10) Pub. No.: US 2006/0147585 A1
(43) Pub. Date: Jul. 6, 2006

(54) Compositions and methods for coating surfaces of confectionery products with electrostatically charged powders

(76) Inventors: Miguel Peinado von Winckelmann, Esparreguera (Barcelona) (ES); Jordi Pujol Casellas, Mollet del Valles (Barcelona) (ES); Brian Ream, Plano, IL (US)

Correspondence Address: BELL, BOYD & LLOYD LLC, P. O. BOX 1135, CHICAGO, IL, 60690-1135, US

(21) Appl. No.: 11/284,698

(22) Filed: Nov. 21, 2005

Related U.S. Application Data
(60) Provisional application No. 60/668,364, filed on Apr. 4, 2005.
(60) Provisional application No. 60/640,560, filed on Dec. 30, 2004.

(51) Int. Cl. A23L 1/216

(52) U.S. Cl. 426/96

(57) ABSTRACT

The present invention relates generally to compositions and methods for applying an electrostatic charge to powders and applying the charged powders to the surfaces of food products, especially confectionery products. The method can be used to reduce sticking of a product as it is being formed and to apply flavorings. The method reduces the amount of powder required to obtain suitable coatings and therefore reduces the amount of powder that is wasted in the coating process. The process is particularly well suited to the application of powders to gum surfaces.

### PRIORITY CLAIM

This application claims the benefit of U.S. Provisional Patent Application Ser. No. 60/668,364 filed on Apr. 4, 2005 and U.S. Provisional Patent Application Ser. No. 60/640,560 filed on Dec. 30, 2004, the entire disclosures of which are hereby incorporated.

### BACKGROUND

In confectionery product manufacturing processes, such as gum manufacturing processes, a product mass is prepared and extruded through an extruder. The mass exits the extruder in the shape of a thick rope or sheet, and in some processes, is sent in a continuous stream at a relatively low speed to a laminating machine. The laminating machine contains several pairs of rollers through which the mass passes. The rollers turn at predefined speeds and progressively laminate the product in a continuous process. Each time the product passes through a pair of rollers its thickness is slightly reduced and its speed through the manufacturing machine increases. At the end of the sheeting process, a very thin layer of product is obtained which moves at a relatively high speed. The mass is then used to obtain different product formats, such as sticks, dragees and the like.

There are a variety of recipes for confectionery products and many of the recipes, particularly gum recipes, produce product masses that are sticky to some degree. The stickiness of a confectionery product creates a problem in the laminating process. In order to laminate a mass between a pair of rollers, a high surface pressure must be applied. This pressure can cause the product to stick to the rollers. If the product sticks to one of the rollers, the product will break and interrupt the process. Not only does this reduce the manufacturing efficiency by increasing the amount of time required to manufacture a product, but it also results in a large amount of scrap which must be recovered.

In the past, efforts have been made to reduce sticking. For example, the rollers used in a typical sheeting machine can be made of stainless steel having a smooth surface that minimizes sticking. In some cases the surface of the rollers can be coated with Teflon® to reduce sticking. However, Teflon coated rollers are fragile and difficult to clean.

Rollers can also be cooled to reduce sticking. For example, chilled water can be circulated inside the rollers. However, this solution can only be used when the dew point in the manufacturing facility is low enough to avoid moisture condensation on the rollers or the cooled gum product.

Liquid anti-sticking agents, such as trenwax oil, have also been used to coat rollers or the product mass. However, this results in a product that is coated with oil, which is a barrier to air and increases the amount of time required for curing.

Another anti-sticking methodology is to coat the surface of a product mass with an anti-sticking powder such as talc. The powder can be introduced into a manufacturing machine at the beginning of the process and used to coat the surface of the product before the product mass reaches the first pair of rollers. To ensure that the confectionery product mass is sufficiently coated in this process, an excess of the powder is usually applied and at the end of the process, brushes and a dust collector system remove and collect the excess powder from the product. The use of excess powder to ensure proper coating of the confectionery product and the use of a separate brushing and a dust collection system at the end of the process render the process less efficient than it would otherwise be if a more effective coating method were known. In addition, the practice of applying excess powder early in the process leads to shedding and waste of the powder as the product passes through the laminating machine. This tends to increase the level of dust in the manufacturing environment. The problems associated with adding powders to confectionery products are also present in the production of other foods in the food industry.

Thus, new methods are needed for applying powders to foods, especially confectionery products, that can reduce the amount of wasted powder and increase the efficiency of food and particularly, confection manufacturing processes.

### SUMMARY

The present invention provides new compositions and methods for manufacturing foods by introducing an electrostatic charge into edible powders and applying the electrostatically charged powders to food products. The compositions and methods are suited for use in coating confectionery product masses, including gum masses, and can be used to reduce wasted powder and increase the efficiency of manufacturing. The present methods can also be used to reduce sticking of food products during manufacturing and to apply flavorings.

In an embodiment the food product is coated with powder and the product is then shaped. Such methods are particularly suitable for reducing sticking of products as they are being formed in laminating or pressing operations. The method reduces the amount of powder required to obtain suitable coatings and can be used to control the amount of powder that is wasted in the coating process.

In an embodiment, the manufacturing process includes a step wherein the food product is extruded through an extruding device. The extrusion process can, in an embodiment, form a rope-shaped food product mass.

In an embodiment, the powder coated food product is subjected to a pressing operation. In the pressing operation the food product mass can be laminated by a desired amount. The pressing operation can occur in one, two or multiple steps through sets of rollers.

The powders can be flavorings, sugars, and/or nonstick powders that reduce the surface stickiness of the food product and their mixtures. In an embodiment, the powder can be a flavoring agent.

In an embodiment, an electrostatic charge is applied to at least two powders and a first portion of the surface of a food product is coated with a first powder and a second portion of the surface of the food product with a second powder. In an embodiment, the first and second portions of the surface of the food product are substantially different surfaces.

In an embodiment, powder is passed from a powder storage container through a powder feed line into a chamber in a powder delivery device that contains an electrode. The electrode is in contact with a voltage source that delivers an electrostatic charge to the powder. The powder passes through the nozzle in the powder delivery device and is delivered to the food product in a pattern.

In an embodiment, the voltage source delivers a voltage to the electrode of up to about 100,000 volts, more preferably from about 10,000 to about 80,000 volts, preferably of from about 25,000 to about 75,000 volts, more preferably of from about 35,000 to about 60,000 volts.

In an embodiment, the powder coating apparatus is configured to introduce an electrostatic charge to a food powder, coats the surface of a food product with the electrostatically charged powder and further includes a powder collector for collecting free powder from the powder coating area. In an embodiment, the powder coating apparatus further comprises a powder collector in vacuum connection with a vacuum line for vacuuming excess powder away from the food product.

In an embodiment, the powder coating apparatus includes a powder feed line for moving powder from a powder storage container through the chamber and nozzle and onto the food product.

In an embodiment, the powder coating apparatus includes a powder feed line for feeding powder from a storage bin to a powder spray nozzle wherein the feed line is an air line.

In an embodiment, the powder coating apparatus includes a powder spray gun that includes a nozzle that completely surrounds the food product mass. In an embodiment, the nozzle is cone shaped. In an embodiment, the nozzle is flat shaped.

In an embodiment, the invention provides a food manufacturing device that includes a powder coating apparatus and is configured to convey a region of the food product in a substantially horizontal direction and to deliver powder in a substantially vertical direction. In an embodiment, a region of the food product is conveyed in a substantially vertical direction and powder delivery is in a substantially horizontal direction.

In an embodiment, the spray nozzle of the powder coating apparatus is positioned to spray powder onto the food product before a pair of laminating rollers. In an embodiment, a spray nozzle is positioned before each roller in the laminating machine.

In an embodiment, the powder coating apparatus contains at least two electrostatic spray nozzles which are configured to deliver at least two distinct powders onto a food product.

The invention provides food products especially including confectionery products, having a coating containing an electrostatically charged powder. The powders can be flavors, sugars, and nonstick powders.

The invention provides in an embodiment, a confectionery manufacturing machine comprising at least one pair of laminating rollers for laminating a confectionery product, a powder delivery device for delivering an electrostatically treated powder to the surface of the confectionery mass before the laminating rollers of the laminating machine; the powder delivery device comprising a chamber having a nozzle outlet for delivering a pattern of the powder to a confectionery product, the chamber containing an electrode in contact with a voltage source for delivering an electrostatic charge to the powder, a powder feed line for moving powder from a powder storage container through the chamber and onto the confectionery product.

Additional features and advantages of the present invention are described in, and will be apparent from, the following Detailed Description and the figures.

### BRIEF DESCRIPTION OF THE FIGURES

FIG. 1 illustrates one embodiment of the invention in which a spray nozzle is spraying an electrostatically charged particle onto the surface of a gum mass.

FIG. 2A illustrates an embodiment containing multiple spray nozzles positioned before every laminating roller.

FIG. 2B illustrates an embodiment in which a spray nozzle is positioned before several laminating rollers.

FIG. 3 illustrates an embodiment of an electrostatic powder spray gun.

FIG. 4 illustrates a diagram of a donut- or cylindrical-shaped spray nozzle particularly useful for powder coating around the circumference of a confectionery mass.

FIG. 5 illustrates a cross section of a powder feed hopper attached to a powder spray gun.

FIG. 6 illustrates an embodiment of a powder spray gun and powder collector.

### DETAILED DESCRIPTION

The present invention provides novel methods and compositions for manufacturing powder coated food products, especially confectionery food products. To this end a batch of a confectionery food product can be prepared and an edible food powder can be treated such that it develops an electrostatic charge. The charged powder can then be used to coat at least a portion of the surface of the confectionery mass to impart desirable characteristics, including nonstickiness, flavor or sweetness. Of course, these characteristics are not mutually exclusive.

Any food product can be treated with the electrostatically charged powder. However, the method is well suited for coating sticky masses with nonsticky powders prior to pressing operations during manufacturing. The method is very well suited for manufacturing the gum products from gum masses. The present methods and compositions also find use in the preparation of toffee, chewies, candy, jellies and other food products including baked goods, etc. Many food product formulations are known and can be used so long as they are in the form or can be formed into masses that can be treated by the disclosed methods.

With gum, the formulation can include an insoluble gum base. The gum base can include elastomers, resins, fats and oils, softeners, inorganic fillers, and can include wax. Typically, a gum base comprises approximately 20 to about 40% by weight of a gum product. However, depending on the product, this can vary. For instance, if a large amount of a coating is used, the gum center is smaller so that the entire coated chewing gum piece is a suitable size for consumption. The insoluble gum base can constitute approximately 30% to about 90% by weight of the chewing gum, in an embodiment, the gum base comprises at least about 50% of the chewing gum.

In an embodiment, the chewing gum base contains about 20% to about 60% by weight synthetic elastomer, about 0% to about 30% by weight natural elastomer, about 5% to about 55% by weight elastomer plasticizer, about 4% to about 35% by weight filler, about 5% to about 35% by weight softener, and optional minor amounts (about 1% or less by weight) of miscellaneous ingredients such as colorants, antioxidants, and the like.

Suitable synthetic elastomers include, polyisobutylene with GPC weight average molecular weight of about 10,000 to about 95,000, isobutylene-isoprene copolymer (butyl elastomer), styrene-butadiene, copolymers having styrene-butadiene ratios of about 1:3 to about 3:1, polyvinyl acetate having GPC weight average molecular weight of about 2,000 to about 90,000, polyisoprene, polyethylene, vinyl acetate-vinyl laurate copolymer having vinyl laurate content of about 5% to about 50% by weight of the copolymer, and combinations thereof.

Preferred ranges for polyisobutylene are 50,000 to 80,000 GPC weight average molecular weight and for styrene-butadiene are 1:1 to 1:3 bound styrene-butadiene, for polyvinyl acetate are 10,000 to 65,000 GPC weight average molecular weight with the higher molecular weight polyvinyl acetates typically used in bubble gum base, and for vinyl acetate-vinyl laurate, vinyl laurate content of 10-45%.

Suitable natural elastomers include natural rubber such as smoked or liquid latex and guayule, as well as natural gums such as jelutong, lechi caspi, perillo, sorva, massaranduba balata, massaranduba chocolate, nispero, rosindinha, chicle, gutta hang kang, and combinations thereof.

Suitable elastomer plasticizers include, natural rosin esters such as glycerol esters or partially hydrogenated rosin, glycerol esters of polymerized rosin, glycerol esters of partially dimerized rosin, glycerol esters of rosin, pentaerythritol esters of partially hydrogenated rosin, methyl and partially hydrogenated methyl esters of rosin, pentaerythritol esters of rosin; synthetics such as terpene resins derived from alpha-pinene, beta-pinene, and/or d-limonene; and any suitable combinations of the foregoing.

Suitable fillers/texturizers can include magnesium and calcium carbonate, ground limestone, silicate types such as magnesium and aluminum silicate, clay, alumina, talc, titanium oxide, mono-, di- and tri-calcium phosphate, cellulose polymers, such as fiber derived from wood, and combinations thereof.

Suitable softeners/emulsifiers include tallow, hydrogenated tallow, hydrogenated and partially hydrogenated vegetable oils, cocoa butter, glycerol monostearate, glycerol triacetate, lecithin, mono-, di- and triglycerides, acetylated monoglycerides, fatty acids (e.g. stearic, palmitic, oleic and linoleic acids); and combinations thereof.

Suitable colorants and whiteners include FD&C-type dyes and lakes, fruit and vegetable extracts, titanium dioxide, and combinations thereof.

In addition to a water insoluble gum base portion, various embodiments of chewing gum can include a water soluble bulk portion and one or more flavoring agents. The water soluble portion can include bulk sweeteners, high-intensity sweeteners, flavoring agents, softeners, emulsifiers, colors, acidulants, fillers, antioxidants, and other components that provide desired attributes.

Softeners can be added to the chewing gum in order to optimize the chewability and mouth feel of the gum. The softeners, which are also known as plasticizers and plasticizing agents, generally constitute between approximately 0.5% to about 15% by weight of the chewing gum. Suitable softeners for use in confectionery products are known in the art and can be used. They include glycerin, lecithin, and combinations thereof, for example. Aqueous sweetener solutions such as those containing sorbitol, hydrogenated starch hydolysates, corn syrup and combinations thereof, can also be used as softeners and binding agents in the present invention.

Bulk sweeteners include both sugar and sugarless components. Bulk sweeteners typically constitute about 5% to about 95% by weight of the chewing gum, more typically, about 20% to about 80% by weight, and more commonly, about 30% to about 60% by weight of the gum. Sugar sweeteners generally include saccharide-containing components commonly known in the art, including but not limited to, sucrose, dextrose, maltose, dextrin, dried invert sugar, fructose, levulose, galactose, corn syrup solids, and the like, alone or in combination. Sugarless sweeteners include sugar alcohols such as sorbitol, mannitol, xylitol, hydrogenated starch hydolysates, maltitol, and the like, alone or in combination.

High-intensity artificial sweeteners can also be used, alone or in combination, with the above. Preferred sweeteners include, but are not limited to, sucralose, aspartame, salts of acesulfame, altitame, saccharin and its salts, cyclamic acid and its salts, glycerrhizinate, dihydrochalcones, thaumatin, monellin, and the like, alone or in combination. In order to provide longer lasting sweetness and flavor perception, it can be desirable to encapsulate or otherwise control the release of at least a portion of the artificial sweetener. Such techniques as wet granulation, wax granulation, spray drying, spray chilling, fluid bed coating, coacervation, and fiber extension can be used to achieve the desired release characteristics.

Combinations of sugar and/or sugarless sweeteners can be used in confectionery products. Additionally, the softener can also provide additional sweetness such as with aqueous sugar or alditol solutions.

If a low calorie confection is desired, a low caloric bulking agent can be used. Examples of low caloric bulking agents include: polydextrose; raftilose, raftilin; fructooligosaccharides (NutraFlora®); palatinose oligosaccharide; guar gum hydrolysate (Sun Fiber®); or indigestible dextrin (Fibersol®). However, other low calorie bulking agents are also suitable.

A variety of flavoring agents can also be used, if desired. The flavor can be used in amounts of about 0.1 to about 15 weight percent of the gum, and preferably, about 0.2% to about 5% by weight. Flavoring agents can include essential oils, synthetic flavors or mixtures thereof including oils derived from plants and fruits such as citrus oils, fruit essences, peppermint oil, spearmint oil, other mint oils, clove oil, oil of wintergreen, anise and the like. Artificial flavoring agents and components can also be used. In an embodiment, natural and artificial flavoring agents can be combined in any fashion acceptable to the senses.

The confectionery product can be mixed using known methods. For example, ingredients can be mixed in a Sigma Blade Mixer or in a continuous extruding mixer.

In one method, once the confectionery mass is prepared, it can be extruded through an extruder and passed to a pressing machine which shapes the mass. The extruder can be used to extrude the mass into any known shape, including sheets or ropes. The extruded mass can then be pressed into a desired shape.

The present method involves coating the confectionery mass with a powder coating. Suitable food powders for this coating include powders that are edible when combined with the food product. Suitable powders impart desired characteristics to the food product and can accept an electrostatic charge to a degree sufficient for use in coating a confectionery mass using an electrostatic spray gun. In addition, suitable powders are sufficiently dry for spraying using the present electrostatic spray method. Powders containing flavors, acids and nonstick properties can be used. Exemplary powders include sugars, such as starch, dextrose, cellulose, maltodextrin, hydrogenated starch hydolysates; sugar powders, such as sugar alcohols, including mannitol, and maltitol powders; sugar acids and other powders such as citric acid or various salts; and nonstick powders, such as talc, dextrose; and their mixtures. Suitable powders have a size that allows for electrostatic delivery and will therefore depend to some extent upon the delivery device employed. The choice of suitable powders is well within the skill of one having skill in the art. Powders having an average particle size of up to 500 μm can be used, more preferably the average particle size will be less than about 100 μm, more preferably less than about 80 μm or smaller are generally suitable.

The present method involves imparting an electrostatic charge to a powder and applying the treated powder to a food mass during manufacturing. The electrostatic charge can be imparted by applying a voltage to an electrode, preferably a negative electrode, and passing the powder within a sufficient distance of the electrode to impart an electrostatic charge into the powder as it passes by the electrode and is directed to the surface of the food mass. Suitable electrostatic spray devices are known and include those used for powder painting. Several of these devices are available commercially from Nordson Corporation and K-TRON Soder. The devices include Corona and Tribo charging devices, as are known. Power supplies for such devices can be either integral or remote but should be capable of delivering at least about 100,000 volts to the electrode. One suitable model commercially available from Nordson is the Versa-Spray® and Versa-Spray® II.

The electrostatic sprayer can be attached to a powder feed hopper that continuously supplies powder to the sprayer. The powder feed hopper is suitably adapted to pass the powder from a storage container through a powder feed line into a chamber in the spray gun. The spray gun chamber can contain an electrode in contact with the voltage source. An electrostatic charge can then be delivered to the powder from the charged electrode as the powder passes through the chamber and exits for delivery to the confection mass.

The spray gun can be fitted with a variety of spray nozzles. Nozzle designs that find use in the present methods include flat, and conical designs having various widths and lengths, as desired. Spray nozzles are positioned at a suitable distance from the product surface to deliver powder to the food surface. In general, the nozzle is a few inches or more from the product surface, as desired.

Any suitable voltage that can charge the powder with an electrostatic charge sufficient to cause it to stick to the target can be used but preferably the lowest voltage that causes the desired amount of powder to stick is used in order to reduce the spurious voltage emissions. Voltages of about 100,000 volts have been found useful. More generally, voltages of from about 10,000 to about 80,000 volts can be used, more preferably voltages from about 25,000 to about 75,000 volts can be used, still more preferably voltages of from about 35,000 to about 60,000 volts can be used.

Preferably, the present methods are carried out in a temperature and humidity controlled environment in order to maintain consistency in the electrostatic spray coating step. A variety of other factors including air flow characteristics in the vicinity of the region to be coated, sprayer to confectionery mass distance and air to powder ratios can all be controlled in ways that can easily be optimized by one of skill in the art for a particular application.

In certain methods several electrostatic charging devices can be used to induce an electrostatic charge into a variety of distinct powders. The powders can then be used to coat the confectionery mass. In this configuration, identical, overlapping or distinct food product surfaces can be coated, as desired. Of course, any number of powders could be applied to food products in this way.

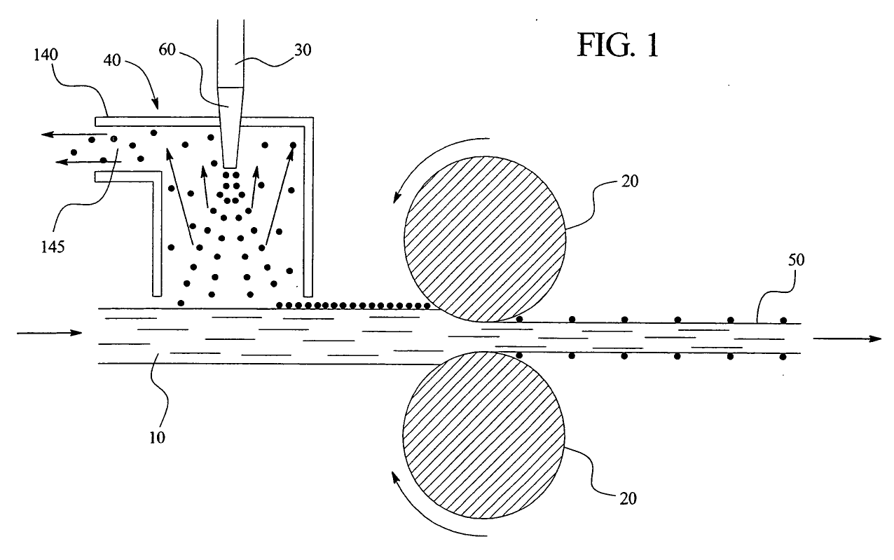

The described methods can be carried out using a powder coating apparatus, as illustrated in FIG. 1. FIG. 1 illustrates a device for coating a surface of a food mass with an electrostatically charged powder. The device includes a powder delivery device (30), which can be an electrostatic spray gun, as described above and in the examples. In this embodiment, the powder delivery device is used to deliver electrostatically charged powder to a surface of a confectionery mass (10) before a roller of a laminating machine (20).

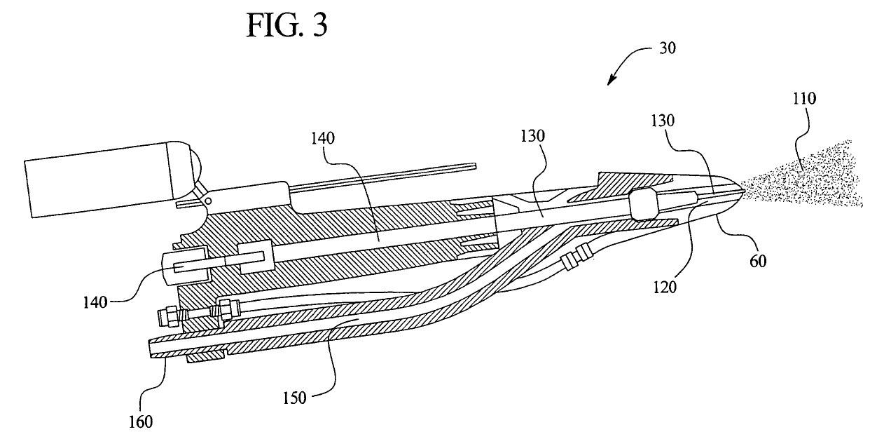

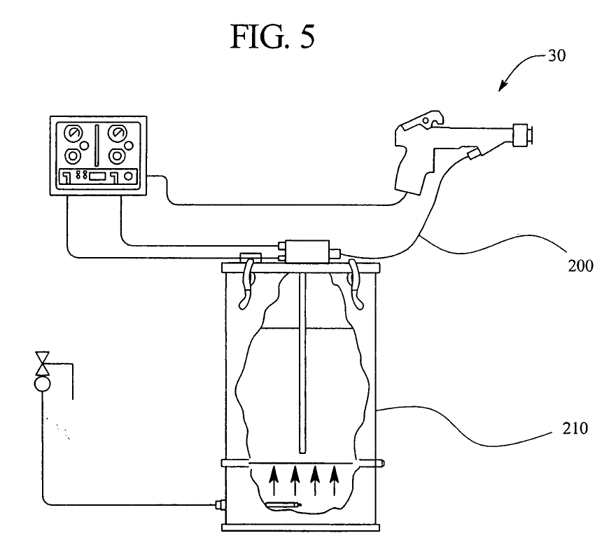

A view of one embodiment of the powder delivery device (30) is illustrated in more detail in FIG. 3. A nozzle (60) is illustrated for delivering a pattern of the powder (110) to a food product. Delivery device (30) has a chamber (120) containing an electrode (130) in contact with a voltage source as input (140) for delivering an electrostatic charge to the powder. In the embodiment of FIG. 5, a device is illustrated having a powder feed line (200) for moving powder from a powder storage container (210) through the chamber (120) and nozzle (60) for delivery to the food product (10). The powder feed mechanism can be used to assist in the supply powder to the spray gun (30) at a uniform and consistent rate. The feed mechanism can operate off of a powder pump using the venturi principle to deliver the powder from the supply hopper to the spray gun.

Referring again to FIG. 1, a powder collector (40) is illustrated for collecting excess powder that does not stick to the food surface. The collector can be attached to a vacuum line which helps to draw off the powder. The powder can then be collected in a collection hopper (not illustrated).

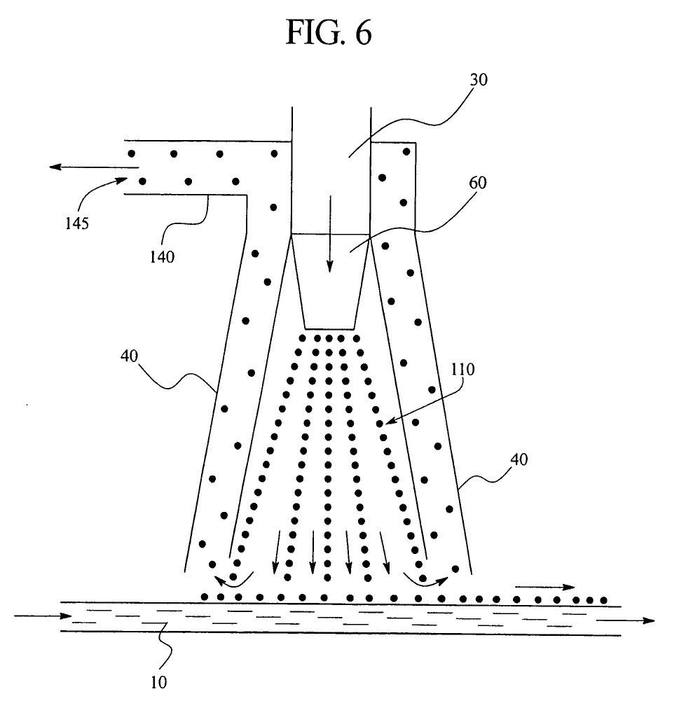

An alternative version of the powder collector is illustrated in FIG. 6. A powder delivery device is illustrated with a nozzle (60) for delivering a pattern of the powder (110) to the food product (10). A powder collector (40) for collecting excess powder is also illustrated. The powder collector can be attached to a vacuum line (145) which helps to draw off excess powder.

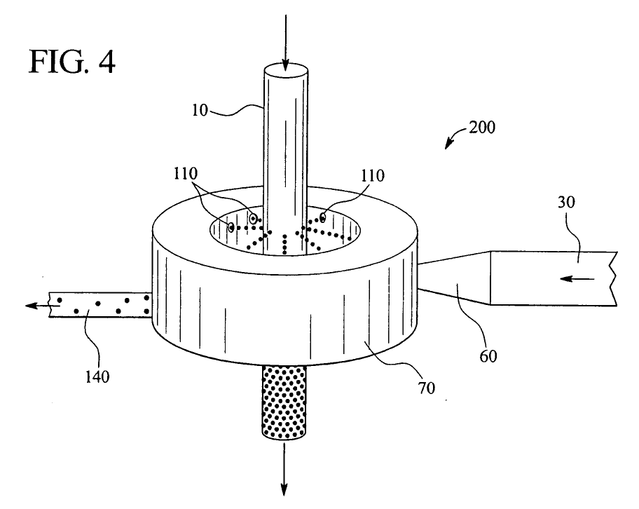

In an embodiment, as illustrated in FIG. 4, the powder coating apparatus has a nozzle (70) that completely surrounds the confectionery product mass. FIG. 4 illustrates an extruded confectionery food mass in the form of a rope (10) passing through the tubular shaped nozzle (70) which serves as a powder injector/dust collector (70). An electrostatic gun (30) is attached to the tubular shaped powder injector/dust collector (70) and injects electrostatically charged powder through the tubular nozzle (70) to the target. The tubular nozzle (70) contains perforations (110) in its interior through which the electrostatically charged powder passes to coat the confectionery rope mass (10). An exit vent (140) is also provided for removing powder that does not stick to the confectionery mass (10). Injector/dust collector (70) drives the flow of charged powder through the tubular shaped injector (30) to the rope (10) in such a way that the rope (10) receives the powder from all directions and is uniformly coated.

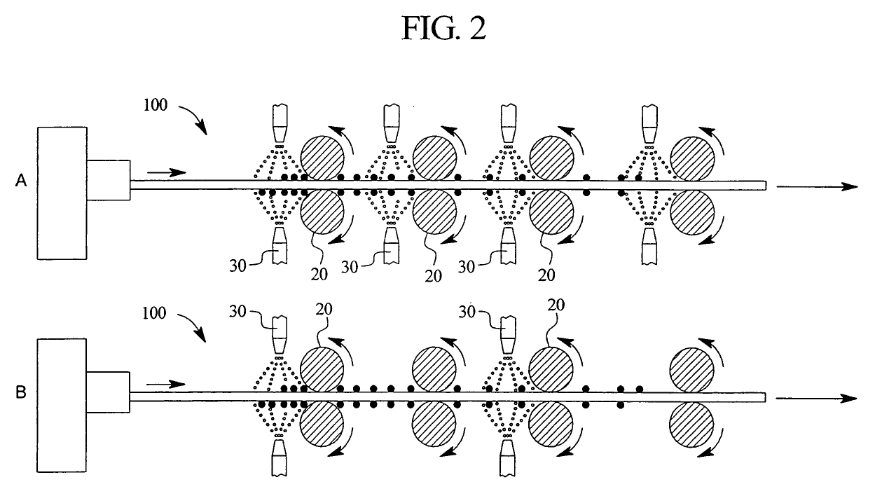

The powder coating apparatus can be configured as in FIGS. 1 and 2 to convey a region of the confectionery mass (10) substantially horizontally through the rollers (20) of a laminating device and a powder delivery device delivers powder in a substantially vertical direction. Alternatively, the device can be configured to convey a region of the confectionery mass (10) substantially vertically and a powder delivery device delivers powder in a substantially horizontal direction, as illustrated in FIG. 4.

FIG. 2A illustrates a powder coating apparatus configured such that a spray nozzle is located before each pair of laminating rollers. Alternatively, as illustrated in FIG. 2B, the powder coating apparatus can be configured such that a nozzle is located before the first roller but is not necessarily positioned before every roller; for example, the powder spray nozzle can be positioned before every other roller or every third roller, as needed. In an embodiment, several spray nozzles can be positioned together at any location in the manufacturing machine. Where multiple spray nozzles are employed, the sprays can be with the same or different powders and can be used simultaneously or alternatively. The use of different powders can be used to apply distinct flavor coatings over different regions of the confection product.

The powder delivery device described above can be used advantageously when employed in a confectionery manufacturing machine, particularly when employed in machines having pressing operations such as laminating operations.

In the following examples, a flavor, colorant, and acid were added to a gum resin prepared from sugar, glucose and a gum base. In the recipes below, percentages represent approximate weight percentages. The recipes were mixed and kneaded. Recipes all were observed to have at least some level of conductivity. The average particle diameter when talc was used was in the range of 250 to about 500 μm.

In the following examples, an electrostatic powder paint gun was obtained (Nordson Corporation model Versa Spray) and used to spray a powder, as set forth in the examples, onto various gum masses in a sheeting machine.

### EXAMPLE 1

This example demonstrates that an electrostatically charged powder can be used to coat a confectionery mass during its manufacture. A gum mass, which is typically very sticky, was prepared according to the Formula 1, shown below, and extruded to feed a laboratory scale sheeting machine. The machine was configured with a Nordson Versa Spray® electrostatic sprayer and a dust collector was used to trap and collect the excess dust that did not adhere to the surface of the confection mass.

### Recipe for Formula 1 (Acid Sugarfree Chewing Gum/Gum Base Filled with Talc)

| Ingredient | Wt. % |
|---|---|
| Sorbitol Powder 60 W B.B. | 48% |
| Gum Base | 30% |
| Maltitol Syrup | 6% |
| xylitol | 5% |
| Glycerin | 5% |
| Flavor | 1.5% |
| Lecithin | 1% |
| Sodium Citrate | 1% |
| Acid (dry) | 2% |
| Aspartame/Acesulfame | 0.5% |

To minimize airborne powder in the vicinity of the manufacturing machine a dust collecting hopper and dust collector were connected to a vacuum to pull off excess powder. The device is illustrated in FIG. 1. FIG. 1 illustrates a sheeting machine (100) in which a sheet of gum (10) travels toward a pair of laminating rollers (20). An electrostatic spray device (30) is illustrated applying an electrostatically charged powder within a dust collecting hopper. Some of the powder particles are illustrated forming a coating on the surface of the gum mass while a portion of the powder is illustrated exiting the dust hopper to a dust collector (not illustrated) (40). Powder can be applied in a similar manner on the opposite side of the gum mass using a similar device positioned underneath the gum mass. As illustrated, the gum mass is laminated (50) upon passing through the rollers (20).

Despite the very simple electrostatic sprayer and collector used in this trial, it was possible to deposit a suitable amount of talc on the surface of the gum mass to avoid sticking and at the same time the production of airborne powder outside the collector was minimal.

In this trial the influence of the different parameters on the deposition of the powder layer was also studied. The voltage in the electrostatic sprayer was varied between about 0 to about 100,000 volts. In this configuration, a minimum value of about 35,000 V was needed to obtain suitable powder dosing. Voltage levels over 60,000 V did not seem to provide any benefit. Regulation of the voltage provided control over the thickness of the powder layer on the surface of the gum mass.

Variation of the powder/air mixture was also observed to have a direct influence on the thickness of the powder layer on the gum surface.

The influence of the nozzle shape on the coating layer was also examined. Two shapes were tested, a cone shape and a flat shape. The flat nozzle was found significantly more suitable than the cone shape at applying a powder layer on a continuous gum rope mass having a width of about 300-400 mm.

Tests were carried out to check the stability of the powder layer when the gun was operated in different positions, including:
Gum mass moving in horizontal position—gun shooting from top to bottom
Gum mass moving in horizontal position—gun shooting from bottom to top
Gum mass moving in vertical position—gun shooting horizontally

In each configuration the powder coating was suitably stable for manufacturing purposes. The distribution of the powder layer onto the product mass was always uniform and did not appear to depend on position or direction of the gun.

The requirement for the number of nozzles was also investigated. One method of ensuring that the process works properly along a sheeting machine could be to employ as many nozzles as there are rollers in the machine, such that a spray coating nozzle would apply a suitable coating of powder before each roller to avoid sticking. FIG. 2A illustrates such a configuration in which a sheeting machine (100) having electrostatic powder spray nozzles (30) coats the gum sheet before rollers (20). In FIG. 2A, a powder sprayer precedes each roller. FIG. 2B, illustrates a demonstrative example in which a powder sprayer precedes the first roller and every other roller. These tests demonstrated that the effectiveness of a nozzle dosing electrostatically charged powder is high and only one nozzle is required for each 2 or 3 rollers.

### EXAMPLE 2

The following example demonstrates the use of the electrostatic spray coating technique on two different gum masses, including:
Formula 1, a sugarfree chewing gum which gum base is filled with talc and contains an acid that increases gum conductivity. (Example 1 recipe).

Formula 2 recipe, a sugary chewing gum in which the gum base is filled with calcium carbonate. It is not acidic and is less conductive:

| Ingredient | Wt. % |
|---|---|
| Sugar Powder | 62% |
| Gum Base | 20% |
| Glucose Syrup | 16% |
| Glycerin | 1% |
| Flavor | 1% |

A mix of starch and glasée sugar was used as a powder for coating the surface. In each case the powder was formed into a suitable nonstick flavor coating. The electrostatic spray coating process was efficient in each case.

### EXAMPLE 3

This example demonstrates the use of the electrostatic spray gun for spraying powders on confectionery compositions under manufacturing conditions. The electrostatic spray nozzles were configured, as in FIG. 6 and used to coat a sugar free gum, Formula 1, manufactured on a sugar free sheeting machine.

The powder spray gun was installed just before the first pair of rollers. The gun was used to apply talc powder alternately on the top and bottom of the gum mass. The machine was run at a speed of about 35 sheets/min. The powder coated the gum surface in each case and was effective in preventing sticking.

### EXAMPLE 4

This example demonstrates the use of an alternate powder coating and dust collector apparatus, as shown in FIG. 4 to coat a gum rope prepared from the recipe below.

### Sugary Bubble Gum/Gum Base Filled with Talc

| Ingredient | Wt. % |
|---|---|
| Sugar Powder | 61% |
| Gum Base | 23% |
| Glucose Syrup | 14% |
| Glycerin | 0.5% |
| Lecithin | 0.2% |
| Flavor | 0.5% |
| Color | 0.1% |

The recipe was prepared and extruded through an extruder and the rope passed through the donut-shaped spray nozzle where it was coated with powder as illustrated by FIG. 4. The equipment and process provides an alternate embodiment and method for coating a food mass with an electrostatically charged powder.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A method for manufacturing a food product, the method comprising:
introducing an electrostatic charge to a powder,
coating at least a portion of the surface of the food product with the electrostatically charged powder, and
shaping the coated food product.

2. The method of claim 1, wherein the food product is a confectionery product.

3. The method of claim 1, wherein the food product is a gum mass.

4. The method of claim 1, further comprising extruding the food product through an extruder.

5. The method of claim 1, further comprising extruding the food product through an extruder into a rope.

6. The method of claim 1, wherein the coated food product is subjected to a pressing operation.

7. The method of claim 1, wherein the food product is subjected to a pressing operation which laminates the product.

8. The method of claim 1, wherein the powder comprises a powder selected from the group consisting of flavors, sugars, nonstick powders and their mixtures.

9. The method of claim 1, wherein the powder comprises a flavoring agent.

10. The method of claim 1, wherein the powder comprises a powder that reduces surface stickiness of the food product.

11. The method of claim 1, further comprising introducing an electrostatic charge to at least two powders and coating at least a first portion of the surface of the food product with a first powder and coating a second portion of the surface of the food product with a second powder.

12. The method of claim 11, wherein the first and second portions of the surface of the food product are substantially different surfaces.

13. The method of claim 1, further comprising passing the powder from a powder storage container through a powder feed line into a chamber in a powder delivery device that contains an electrode in electrical contact with a voltage source for delivering an electrostatic charge to the powder; through a nozzle in the powder delivery device and delivering a pattern of the powder onto the food product.

14. The method of claim 13, wherein the electrostatic charge is introduced into the powder by delivering a voltage from voltage source to electrode of from about 10,000 to about 80,000 volts.

15. The method of claim 13, wherein the electrostatic charge is introduced into the powder by delivering a voltage from the voltage source to the electrode of from about 25,000 to about 75,000 volts.

16. The method of claim 13, wherein the electrostatic charge is introduced into the powder by delivering a voltage from the voltage source to the electrode of from about 35,000 to about 60,000 volts.

17. A powder coating apparatus comprising an electrode in a powder delivery device for introducing an electrostatic charge to a food powder, and configured to coat the surface of a food product in a food manufacturing apparatus with the electrostatically charged powder, further comprising a powder collector for collecting free powder.

18. The powder coating apparatus of claim 17, wherein the food product is a confectionery mass.

19. The powder coating apparatus of claim 17, wherein the electrode is housed within a chamber configured with a nozzle for delivering a pattern of the powder to the food product.

20. The powder coating apparatus of claim 19, further comprising a powder feed line for moving powder from a powder storage container through the chamber and nozzle and onto the food product.

21. The powder coating apparatus of claim 20, wherein the powder feed line is an air line.

22. The powder coating apparatus of claim 17, further comprising a powder collector for collecting excess powder from the food powder coating area.

23. The powder coating apparatus of claim 17, further comprising a powder collector for collecting excess powder comprising a vacuum line for vacuuming excess powder away from the food product.

24. The powder coating apparatus of claim 17, further comprising a voltage source that can deliver up to about 100,000 volts to an electrode disposed on the device.

25. The powder coating apparatus of claim 17, further comprising a nozzle that completely surrounds the food product mass.

26. The powder coating apparatus of claim 17, further comprising a cone shaped nozzle.

27. The powder coating apparatus of claim 17, further comprising a flat shaped nozzle.

28. A food manufacturing device comprising a powder coating apparatus comprising an electrode for introducing an electrostatic charge to a food powder and coat the surface of a food product with the electrostatically charged powder; a means for shaping the powder coated food product and a powder collector for collecting free powder.

29. The food manufacturing device of claim 28, wherein the device is configured to convey a region of the food product substantially horizontally and the powder delivery device is configured to deliver powder in a substantially vertical direction.

30. The food manufacturing device of claim 28, wherein the device is configured to convey a region of the food product substantially vertically and the powder delivery device is configured to deliver powder in a substantially horizontal direction.

31. The food manufacturing device of claim 28, further comprising a laminating machine comprising laminating rollers and a spray nozzle for spraying powder before at least one pair of laminating rollers.

32. The food manufacturing device of claim 28, further comprising a laminating machine comprising laminating rollers and a spray nozzle for spraying powder before each roller in the laminating machine.

33. The food manufacturing device of claim 28, wherein the device is configured with multiple electrostatic powder delivery devices for delivering multiple distinct powders onto a food product.

34. The food manufacturing device of claim 28, comprising at least two electrostatic powder delivery devices capable of delivering at least two distinct powders onto the food product.

35. A confectionery product comprising:
a coating comprising an electrostatically charged powder selected from the group consisting of flavors, sugars, and nonstick powders.

36. A confectionery manufacturing machine comprising:
a laminating machine comprising at least one pair of rollers for laminating a confectionery product,
a powder delivery device for delivering powder to the surface of the confectionery product before the rollers of the laminating machine; the powder delivery device comprising a chamber containing an electrode in contact with a voltage source for delivering an electrostatic charge to the powder, a nozzle for delivering a pattern of the powder to the confectionery product, a powder feed line for moving powder from a powder storage container through the chamber and nozzle onto the confectionery product.
